(19) United States
(12) Patent Application Publication
(10) Pub. No.: US 2005/0286555 A1
(43) Pub. Date: Dec. 29, 2005

(54) Data transfer system, communication protocol conversion cradle, address conversion method used therefor, and program thereof

(75) Inventor: Katsutoshi Hayashi, Kanagawa (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Infrontia Corporation

(21) Appl. No.: 11/147,444

(22) Filed: Jun. 8, 2005

(30) Foreign Application Priority Data
Jun. 23, 2004 (JP) 184372/2004

(51) Int. Cl. H04J 3/16; H04J 3/22

(52) U.S. Cl. 370/466

(57) ABSTRACT

The present invention provides a data transfer system that enables the number of IP addresses utilized to be reduced. When a hand-held terminal starts sending data to a server, a cradle converts a source IP address in an IP header inside an IP packet sent from the hand-held terminal to server from the hand-held terminal side IP address to the cradle IP address, and then passes the data to server. Server determines that the data was sent from cradle based on the received IP packet, and sends a reply to cradle. Since cradle has to send the received IP packet in reply to hand-held terminal, cradle converts the destination IP address inside the IP header from the IP address of the cradle itself to the IP address of the hand-held terminal, and then sends the data.

### BACKGROUND OF THE INVENTION

1. Field of the Invention

The present invention relates to a data transfer system, a communication protocol conversion cradle, an address conversion method used therefor and a program thereof, and more particularly to the address conversion for connecting a hand-held terminal to a network.

2. Description of the Prior Art

When utilizing a hand-held terminal for business purposes, from the viewpoints of operability and ruggedness the use of a non-contact system is desirable for communication between the hand-held terminal and a server when physically connecting the hand-held terminal with a connector. A cradle that utilizes infrared-ray communication is frequently used as one of these kinds of systems. Other methods for connecting a hand-held terminal with a server or the like through a cradle include a wired connection (for example, see Patent Documents 1and 2).

For reasons such as communication speed, direct data transmission to a server and restrictions on the number of terminals that can be connected simultaneously, the use of a LAN (Local Area Network) as a cradle communication system is increasing. When using a LAN, because of reasons such as limits to the number of IP (Internet Protocol) addresses that can be allocated because of security or network restrictions, there are increasing demands for cradles to have IP addresses.

The operation of a DHCP (Dynamic Host Configuration Protocol) that allocates IP addresses automatically is described referring to FIG. 6. When connecting a hand-held terminal with a server, a problem is where to allocate the IP address.

In the case of a DHCP server 51, when data transmission is conducted from a hand-held terminal 53 to the DHCP server 51 (c1, c2 in FIG. 6), the MAC (Media Access Control) address (=12:34:56:78:9A:BC) of a cradle 52 itself is sent to the DHCP server 51 (c3, c4 in FIG. 6).

The DHCP server 51 then assigns an IP address with respect to the received MAC address (c5, c6 in FIG. 6). When the hand-held terminal 53 receives the allocated IP address, it sets that IP address as the IP address of its own terminal (c7 in FIG. 6).

In this environment, setting an IP address for the hand-held terminal 53 does not involve much trouble, and since an IP address is allocated to the hand-held terminal 53 at the time of connection, the number of IP addresses that the DHCP server 51 allocates is restricted to the same number as the number of the cradles 52. However, there are cases in which DHCP cannot be used due to security or server functions.

Therefore, there are cases in which hand-held terminals are allowed to have their own IP addresses. The operations in this case are as shown in FIG. 7. In this case, data transmission is conducted directly from a hand-held terminal 63 to the IP address (=192.0.0.1) of a server 61 (d1, d2 in FIG. 7).

When the server 61 determines from the received data that the source IP address is that of the hand-held terminal 63 (IP=10.0.0.1), it returns a response to the hand-held terminal 63 (d3 in FIG. 7).

[Patent Document 1] Japanese Patent Laid-Open No. 2003-339000

[Patent Document 2] Japanese Patent Laid-Open No. 2004-046302

In the above-described conventional method of connecting hand-held terminals to a network, when the hand-held terminals have been given their own IP addresses, each hand-held terminal connecting to the network has an IP address. Thus, when there is a plurality of cradles, the number of IP addresses of the hand-held terminals must be greater than that of the cradles to avoid collisions occurring between IP addresses.

Further, in the conventional method for connecting hand-held terminals to a network, when the combinations of connections between cradles and hand-held terminals are not fixed, IP address collisions will occur unless the number of IP addresses allocated matches the number of hand-held terminals. Accordingly, to reduce the number of IP addresses and prevent IP address collisions it is necessary to give an IP address to a connecting cradle.

### BRIEF SUMMARY OF THE INVENTION

Therefore, an object of this invention is to solve the problems described above by providing a data transfer system, a communication protocol conversion cradle, an address conversion method used therefor and a program thereof, that can allow a reduction in the number of IP addresses utilized.

More specifically, a data transfer system according to this invention is a data transfer system that connects a hand-held terminal to a network by use of a communication protocol conversion cradle, wherein the communication protocol conversion cradle comprises a first holding means that holds an IP (Internet Protocol) address of a terminal side for connecting to the network; a second holding means that holds an IP address of the network side; and means that converts an IP address of the hand-held terminal into an IP address of the means itself and sends the IP address of the means itself to the network side, and converts an IP address of the network side into an IP address of the means itself and sends the IP address of the means itself to the hand-held terminal side.

A communication protocol conversion cradle according to this invention is a communication protocol conversion cradle that connects a hand-held terminal to a network, wherein the communication protocol conversion cradle comprises a first holding means that holds an IP (Internet Protocol) address of a terminal side for connecting to the network; a second holding means that holds an IP address of the network side; and means that converts an IP address of the hand-held terminal into an IP address of the means itself and sends the IP address of the means itself to the network side, and converts an IP address of the network side into an IP address of the means itself and sends the IP address of the means itself to the hand-held terminal side.

An address conversion method according to this invention is used in a data transfer system that connects a hand-held terminal to a network by use of a communication protocol conversion cradle, wherein on the communication protocol conversion cradle side, there is performed processing that converts an IP address of the hand-held terminal into an IP address of the communication protocol conversion cradle and sends the IP address of the communication protocol conversion cradle to the network side and processing that converts an IP address of the network side into an IP address of the communication protocol conversion cradle and sends the IP address of the communication protocol conversion cradle to the hand-held terminal side.

A program of an address conversion method according to this invention is a program of an address conversion method used in a data transfer system that connects a hand-held terminal to a network by use of a communication protocol conversion cradle, wherein on the communication protocol conversion cradle side, the program executes processing that converts an IP address of the hand-held terminal into an IP address of the communication protocol conversion cradle and sends the IP address of the communication protocol conversion cradle to the network side and processing that converts an IP address of the network side into an IP address of the communication protocol conversion cradle and sends the IP address of the communication protocol conversion cradle to the hand-held terminal side.

That is, the communication protocol conversion cradle of this invention is also referred to as a “protocol conversion adapter”, and when connecting a hand-held terminal to a network, it utilizes infrared-ray communication by an IrDA (Infrared Data Association) non-contact system to connect the hand-held terminal to a wired Ethernet (registered trademark) environment.

In this case, the communication protocol conversion cradle of this invention is provided with a terminal-side IP address for connecting to the network. Thus, even in a case in which the hand-held terminal has an IP address, by converting that IP address, it is possible for a server to conduct data communication with the hand-held terminal as though the server were communicating with the cradle, and it is possible for the hand-held terminal to carry out pseudo-communication as though the hand-held terminal were communicating directly with the server.

More specifically, the communication protocol conversion cradle of this invention determines the source and the destination of a data packet from the source IP address and the destination IP address inside the IP header, and the cradle can thus masquerade as the source by converting the source IP address when sending a packet. Further, since the sender's reply is to the source IP address inside the packet when data is being sent to a masqueraded destination, by returning the destination IP address in the reply data to the original source IP address, a response can be returned as though there were no masquerading.

According to the communication protocol conversion cradle of this invention, since the cradle is allowed to have an IP address, the number of IP addresses to be administered from the server side is dependent on the number of cradles. Thus, because the number of hand-held terminals connecting to cradles is normally greater than the number of cradles, this invention enables a reduction in the number of IP addresses utilized.

Further, according to the communication protocol conversion cradle of this invention, since an IP address that is possessed by the hand-held terminal side may be any kind of IP address, even in a case in which a hand-held terminal utilized in a remote business office or the like is employed for shared use as a stand-by machine, the time and labor of a system administrator can be reduced as it is not necessary to conduct an IP address changeover for the hand-held terminal, and the introduction time can also be reduced as it is not necessary to change settings or the like.

In addition, since the communication protocol conversion cradle of this invention utilizes an IP address and IP communication, the security of communication can be ensured.

According to the communication protocol conversion cradle of this invention, when the hand-held terminal is a conventional terminal with an IP address, a conventional protocol (IrLAN) that translates between IrDA and LAN (Local Area Network) can be utilized as it is.

It is possible for a hand-held terminal to utilize the communication protocol conversion cradle of this invention without the hand-held terminal being aware of whether the cradle is a cradle without an IP address or is a cradle with an IP address, and there is no necessity to assign a cradle to individual terminals. It is thus possible to reduce introduction costs and operations management costs.

According to this invention, it is possible to reduce the number of IP addresses utilized in a system by employing the configuration and operations described hereunder.

### BRIEF DESCRIPTION OF THE DRAWINGS

FIG. 1 is a block diagram showing the configuration of a data transfer system according to one embodiment of this invention;

FIG. 2 is a block diagram showing the configuration of the cradle of FIG. 1;

FIG. 3 is a view showing a configuration example of an IP packet used in a mobile communication network according to one embodiment of this invention;

FIG. 4 is a sequence chart showing the operations of a data transfer system according to one embodiment of this invention;

FIG. 5 is a sequence chart showing the operations of a data transfer system according to another embodiment of this invention;

FIG. 6 is a sequence chart showing one example of the operations of a data transfer system according to the prior art; and

FIG. 7 is a sequence chart showing another example of the operations of a data transfer system according to the prior art.

### DETAILED DESCRIPTION OF THE PREFERRED EMBODIMENTS

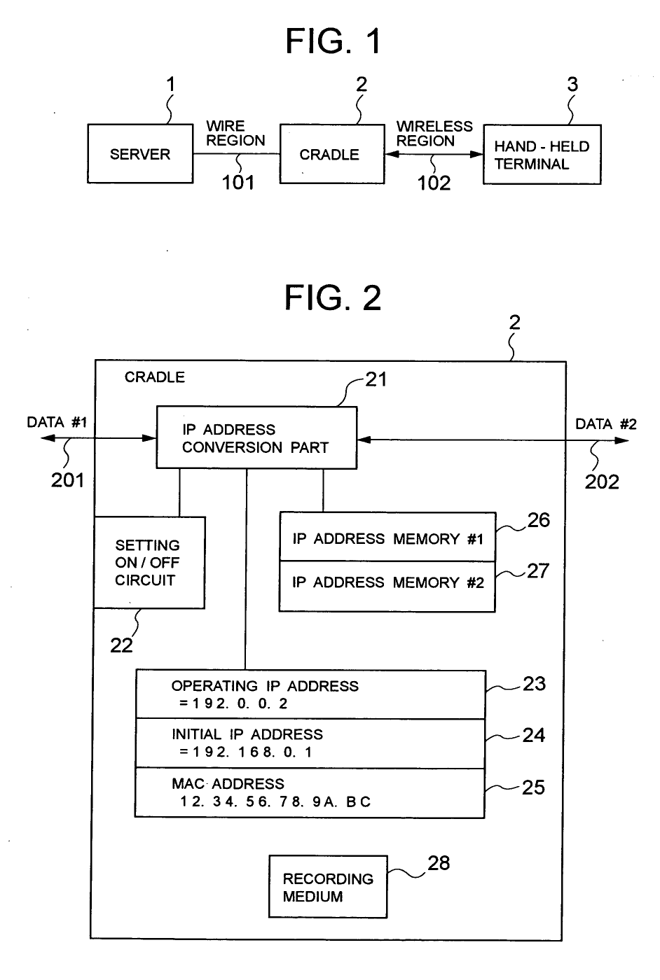

Next, embodiments of this invention will be described referring to the drawings. FIG. 1 is a block diagram showing the configuration of a data transfer system according to the first embodiment of this invention. In FIG. 1, the data transfer system according to the first embodiment of this invention is composed of a server 1, a cradle 2 that is connected to the server 1 by a wire region 101, and a hand-held terminal 3 that is connected to the cradle 2 by a wireless region 102.

FIG. 2 is a block diagram showing the configuration of the cradle 2 of FIG. 1. In FIG. 2, the cradle 2 is composed of an IP (Internet Protocol) address conversion part 21, a settings on/off circuit 22, an operating IP address holding region 23, an initial IP address holding region 24, a MAC (Media Access Control) address holding region 25, an IP address memory (#1) 26, an IP address memory (#2) 27, and a recording medium 28.

The recording medium 28 stores a computer-executable program, and when the cradle 2 is composed of a computer comprising a CPU (central processing unit) and a RAM (random access memory), which are not shown in the figure, operations such as control, or the like, of each circuit described above are implemented by the CPU executing a program stored on the recording medium 28.

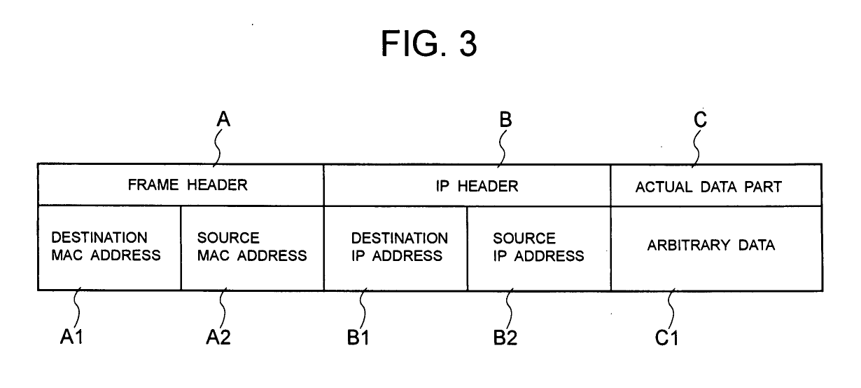

FIG. 3 is a view showing a configuration example of an IP packet used in a mobile communication network according to the first embodiment of this invention. In FIG. 3, the IP packet is composed of a frame header (Ethernet (registered trademark) header) A, an IP header B, and an actual data part C.

The frame header A is composed of a destination MAC address A1 and a source MAC address A2, the IP header B is composed of a destination IP address B1 and a source IP address B2, and the actual data part C is composed of arbitrary data C1.

The source and destination of the data packet are determined from the destination IP address B1 and the source IP address B2 in the IP header B. In this respect,it is possible to masquerade as the source by converting the source IP address B2 when sending the data packet.

Further, for data transmission to a masqueraded destination, since the sender's reply is sent to the source IP address B2 inside the data packet, by returning the destination IP address B1 in the reply data to the original source IP address, a response can be returned as though there were no masquerading.

The cradle 2 will now be described referring to FIG. 1 to FIG. 3. The cradle 2 is a medium that connects the server 1 and the hand-held terminal 3, and it allows data to flow between data(#1) 201 on the server 1 side and data (#2) 202 on the hand-held terminal 3 side.

It is necessary for the cradle 2 to control a total of three IP addresses. These are the operating IP address of the operating IP address holding region 23 that is the IP address of the cradle itself, the IP address of the server 1 side, and the IP address of the hand-held terminal 3 side. The IP address memory (#1) 26 manages the server 1 side IP address, and the IP address memory (#2) 27 manages the IP address of the hand-held terminal 3 side.

When conducting exchanges with these IP addresses between the data (#1) 201 and the data (#2) 202, by converting the destination IP address B1 and the source IP address B2 of the IP header B into the IP address of the IP address memory (#1) 26 and the IP address of the IP address memory (#2) 27, operations can be carried out as though the server 1 itself is communicating with the operating IP address of the operating IP address holding region 23 possessed by the cradle 2.

Therefore, regardless of the manner in which the IP address of the hand-held terminal side is allocated, the only IP address that the server 1 is required to manage is the operating IP address allocated to the cradle 2. This makes it possible to limit the quantity of IP addresses.

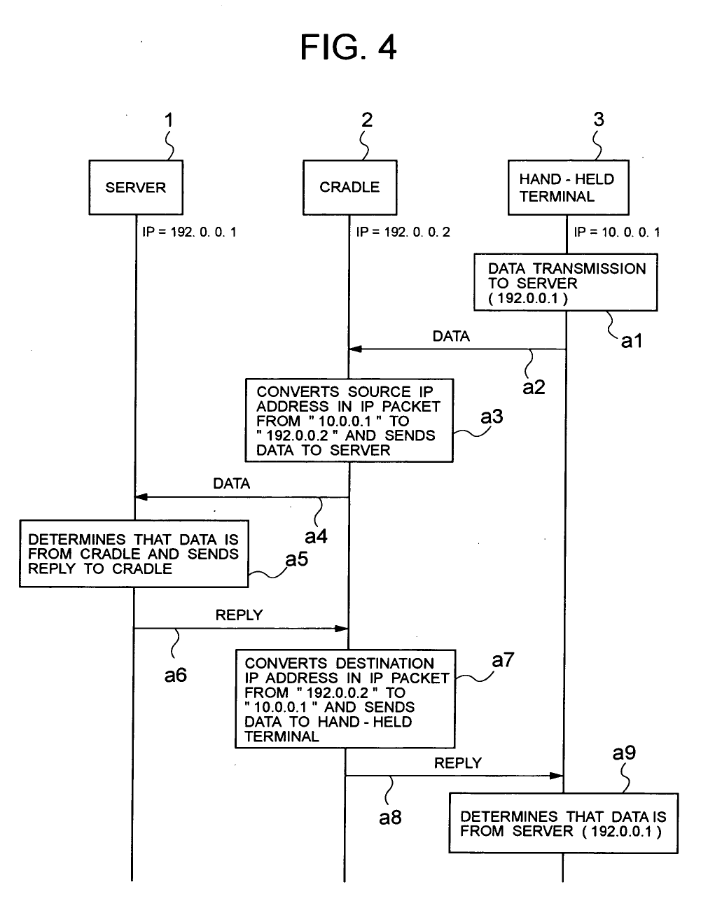

FIG. 4 is a sequence chart showing the operations of a data transfer system according to the first embodiment of this invention. The operations of the data transfer system according to the first embodiment of this invention will now be described referring to FIG. 1 to FIG. 4. For the operations shown in FIG. 4, the processing of the cradle 2 is implemented by the CPU executing a program stored on the recording medium 28.

The IP address of the server 1 is set as “server IP address=192.0.0.1”, the IP address of the cradle 2 is set as “cradle IP address=192.0.0.2”, and the IP address of the hand-held terminal 3 is set as “hand-held terminal side IP address=10.0.0.1”.

When the hand-held terminal 3 starts to send data to the server 1 (a1 in FIG. 4) and the cradle 2 receives an IP packet for the server 1 from the hand-held terminal 3 (a2 in FIG. 4), the cradle 2 converts the source IP address B2 in the IP header B in the IP packet from “hand-held terminal side IP address=10.0.0.1”to “cradle IP address=192.0.0.2”, and then passes the IP packet to the server 1 (a3 and a4 in FIG. 4).

The server 1 determines from the received IP packet that the data was sent from the cradle 2, and sends a reply to “cradle IP address=192.0.0.2” (a5 and a6 in FIG.4). Since it is necessary for the cradle 2 to send a reply with the received IP packet to the hand-held terminal 3, the cradle 2 converts the destination IP address B1 inside the IP header B from “cradle IP address=192.0.0.2”, the IP address of the cradle itself, to “hand-held terminal side IP address=10.0.0.1”, and then sends the data (a7 and a8 in FIG. 4).

Since the source IP address B2 in the IP header B of the received IP packet is “server IP address=192.0.0.1”, the hand-held terminal 3 determines that the data is from the server 1 (a9 in FIG. 4). Therefore, it is not relevant what the IP address of the hand-held terminal 3 side is when sending data according to this data transfer system.

Thus, according to this embodiment, because the cradle 2 has an IP address, the number of IP addresses to be managed from the server 1 side is dependent on the number of the cradles 2. Since the number of hand-held terminals 3 connecting to the cradles 2 is normally greater than the number of cradles, this embodiment enables the number of IP addresses utilized to be reduced.

According to this embodiment, since an IP address assigned to the hand-held terminal 3 side may be any kind of IP address, even in a case in which a hand-held terminal 3 that is utilized in a remote business office or the like is employed for shared use as a stand-by machine, the time and labor of a system administrator can be reduced as it is not necessary to conduct an IP address changeover for the hand-held terminal 3, and the introduction time can also be reduced as it is not necessary to change settings or the like.

In addition, since this embodiment utilizes an IP address and IP communication, the security of communication can be ensured.

According to this embodiment, even when the hand-held terminal 3 has an IP address, as in the prior art, a conventional protocol (IrLAN) that translates between IrDA (Infrared Data Association) and LAN (Local Area Network) can be utilized as it is.

In this embodiment, since the hand-held terminal 3 can use the system without being aware of whether the cradle 2 is a cradle without an IP address or is a cradle with an IP address, it is not necessary to assign a cradle 2 to each hand-held terminal 3. This enables introduction costs and operations management costs to be reduced.

In this embodiment, the wireless system between the hand-held terminal 3 and the cradle 2 needs not be infrared rays, and electromagnetic induction can also be used.

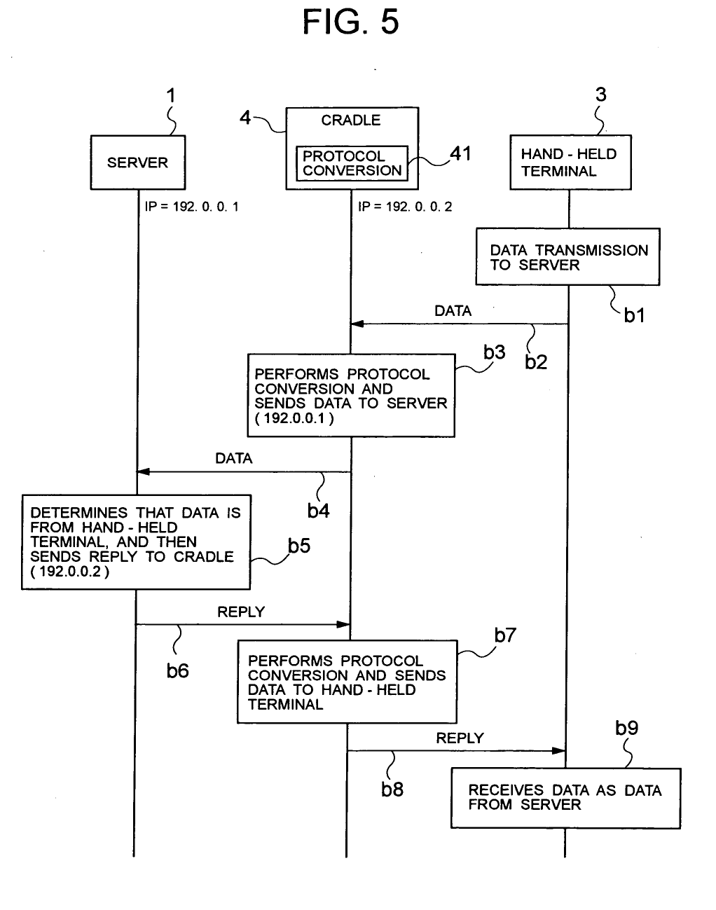

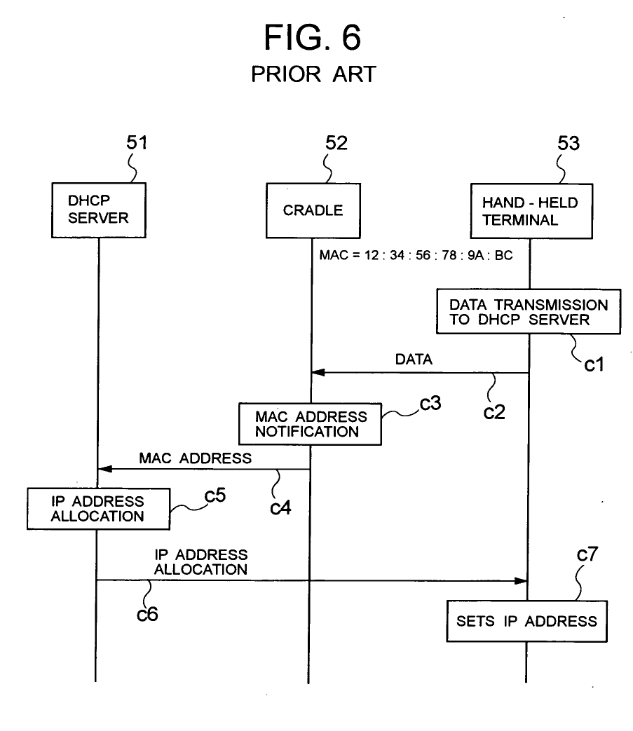

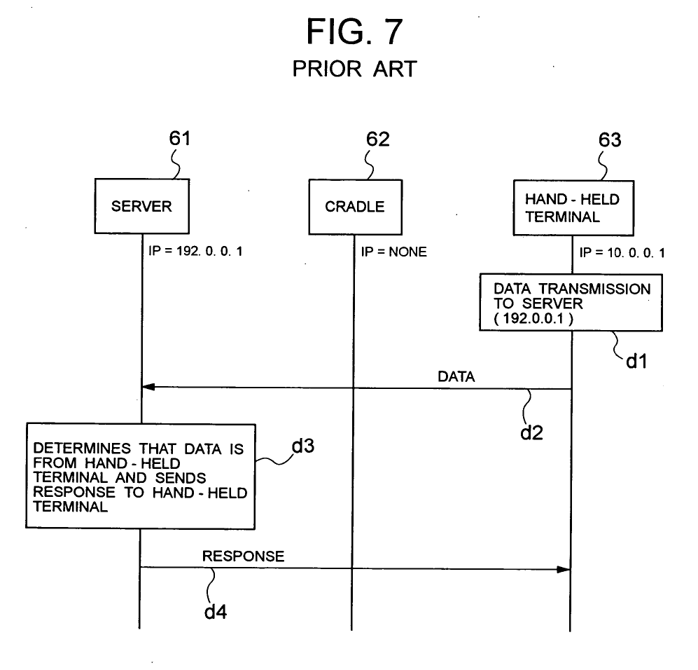

FIG. 5 is a sequence chart showing the operation of a data transfer system according to another embodiment of this invention The data transfer system according to this embodiment has the same configuration as the data transfer system according to the first embodiment of this invention shown in FIG. 1. Further, although not shown in the figure, a cradle 4 has the same configuration as the cradle 2 shown in FIG. 2, except that the cradle 4 is provided with a protocol conversion part 41.

This embodiment of the invention shows the operations in a case in which the hand-held terminal 3 does not have an IP address. As shown in FIG. 5, in the protocol conversion part 41 inside the cradle 4, conversion between TCP/IP (Transmission Control Protocol/Internet Protocol) communication and the dedicated protocol for communication between the cradle 4 and the hand-held terminal 3 is carried out to establish communication between the hand-held terminal 3 and the server 1.

When the hand-held terminal 3 starts to send data to the server (b1 in FIG. 5), the cradle 4 receives an IP packet for the server 1 from the hand-held terminal 3 (b2 in FIG. 5). The cradle 4 then carries out conversion (protocol conversion) in the protocol conversion part 41 between TCP/IP communication and the dedicated protocol for communication between the cradle 4 and the hand-held terminal 3 with respect to the IP packet from the hand-held terminal 3, and sends the data to the server (server IP address=192.0.0.1) (b3, b4 in FIG. 5).

The server 1 determines that the data from the cradle 4 is data from the hand-held terminal 3, and then sends a reply to the cradle 4 (cradle IP address=192.0.0.2) (b5, b6 in FIG. 5). The cradle 4 conducts protocol conversion for the IP packet from the server 1, and then sends the data to the hand-held terminal 3 (b7, b8 in FIG. 5).

Since the source IP address B2 in the IP header B of the received IP packet is “server IP address=192.0.0.1”, the hand-held terminal 3 receives the IP packet as data from the server 1 (b9 in FIG. 5).

This invention can be applied to a system configuration that utilizes a LAN system when conducting data communication between a hand-held terminal and a server or a personal computer.

1. A data transfer system that connects a hand-held terminal to a network by use of a communication protocol conversion cradle, wherein the communication protocol conversion cradle comprises a first holding means that holds an IP (Internet Protocol) address of a terminal side for connecting to the network; a second holding means that holds an IP address of the network side; and means that converts an IP address of the hand-held terminal into an IP address of the means itself and sends the IP address of the means itself to the network side, and converts an IP address of the network side into an IP address of the means itself and sends the IP address of the means itself to the hand-held terminal side.

2. The data transfer system according to claim 1, wherein the communication protocol conversion-cradle determines a source and a destination of a data packet from a destination IP address and a source IP address inside an IP header, and converts the source IP-address when sending the data packet.

3. The data transfer system according to claim 2, wherein the communication protocol conversion cradle returns the destination IP address in a reply data to the original source IP address.

4. The data transfer system according to claim 1, wherein the communication protocol conversion cradle includes means that performs conversion between a communication protocol for the hand-held terminal and the means itself and a communication protocol of the network side.

5. The data transfer system according to claim 1, wherein infrared-ray communication by an IrDA (Infrared Data Association) non-contact system is utilized for communication between the hand-held terminal and the communication protocol conversion cradle.

6. A communication protocol conversion cradle that connects a hand-held terminal to a network, wherein the communication protocol conversion cradle comprises a first holding means that holds an IP (Internet Protocol) address of a terminal side for connecting to the network; a second holding means that holds an IP address of the network side; and means that converts an IP address of the hand-held terminal into an IP address of the means itself and sends the IP address of the means itself to the network side, and converts an IP address of the network side into an IP address of the means itself and sends the IP address of the means itself to the hand-held terminal side.

7. The communication protocol conversion cradle according to claim 6, wherein the communication protocol conversion cradle determines a source and a destination of a data packet from a destination IP address and a source IP address inside an IP header, and converts the source IP address when sending the data packet.

8. The communication protocol conversion cradle according to claim 7, wherein the communication protocol conversion cradle returns the destination IP address in a reply data to the original source IP address.

9. The communication protocol conversion cradle according to claim 6, wherein the communication protocol conversion cradle includes means that performs a conversion between a communication protocol for the hand-held terminal and the means itself and a communication protocol of the network side.

10. The communication protocol conversion cradle according to claim 6, wherein infrared-ray communication by an IrDA (Infrared Data Association) non-contact system is utilized for communication between the hand-held terminal and the communication protocol conversion cradle.

11. An address conversion method used for a data transfer system that connects a hand-held terminal to a network by use of a communication protocol conversion cradle, wherein processing is performed on the communication protocol conversion cradle side that converts an IP address of the hand-held terminal into an IP address of the communication protocol conversion cradle and sends the IP address of the communication protocol conversion cradle to the network side, and converts an IP address of the network side into an IP address of the communication protocol conversion cradle and sends the IP address of the communication protocol conversion cradle to the hand-held terminal side.

12. The address conversion method according to claim 11, wherein the communication protocol conversion cradle is provided with a first holding means that holds an IP (Internet Protocol) address of a terminal side for connecting to the network, and a second holding means that holds an IP address of the network side.

13. The address conversion method according to claim 11, wherein the communication protocol conversion cradle determines a source and a destination of a data packet from a destination IP address and a source IP address inside an IP header, and converts the source IP address when sending the data packet.

14. The address conversion method according to claim 13, wherein the communication protocol conversion cradle returns the destination IP address in a reply data to the original source IP address.

15. The address conversion method according to claim 11, wherein processing is performed on the communication protocol conversion cradle side that converts between a communication protocol for the hand-held terminal and the communication protocol conversion cradle and a communication protocol of the network side.

16. The address conversion method according to claim 11, wherein infrared-ray communication by an IrDA (Infrared Data Association) non-contact system is utilized for communication between the hand-held terminal and the communication protocol conversion cradle.

17. A program of an address conversion method used for a data transfer system that connects a hand-held terminal to a network by use of a communication protocol conversion cradle, wherein the program is a program for executing, on a computer on the communication protocol conversion cradle side, processing that converts an IP address of the hand-held terminal into an IP address of the communication protocol conversion cradle and sends the IP address of the communication protocol conversion cradle to the network side, and processing that converts an IP address of the network side into an IP address of the communication protocol conversion cradle and sends the IP address of the communication protocol conversion cradle to the hand-held terminal side.
